(19) United States
(12) Patent Application Publication
(10) Pub. No.: US 2026/0214082 A1
(43) Pub. Date: Jul. 23, 2026

(54) DATA AT REST ENCRYPTION FOR MULTI-TENANT SCENARIOS USING A CPU

(71) Applicant: Microsoft Technology Licensing, LLC, Redmond, WA (US)

(72) Inventor: Monish Shantilal SHAH, Pune (IN)

(73) Assignee: Microsoft Technology Licensing, LLC, Redmond, WA (US)

(21) Appl. No.: 19/035,254

(22) Filed: Jan. 23, 2025

(51) Int. Cl. H04L 9/40; H04L 9/06

(52) U.S. Cl. CPC H04L 63/0464; H04L 9/0631

(57) ABSTRACT

This document relates to secure storage techniques that can be employed in a multi-tenant environment. In the disclosed implementations, a host CPU can perform data at rest encryption on data that is written to an SSD via an interposer. By offloading the data at rest encryption from the interposer to the CPU, the complexity and power consumption of the interposer can be reduced. Furthermore, redundant cryptographic operations can be mitigated, because the interposer and CPU do not necessarily perform link encryption on data payloads themselves. Rather, link encryption can be limited to associated command data used to configure transfers of encrypted data payloads.

### BACKGROUND

Cloud computing offers tenants the ability to access high-performance computing resources at a fraction of the cost of owning their own equipment. Furthermore, cloud computing is very scalable and flexible, and can accommodate fluctuating demands for computing resources by different tenants over time. However, cloud computing often involves different tenants processing sensitive data on the same physical machine, which can present security concerns.

### SUMMARY

This Summary is provided to introduce a selection of concepts in a simplified form. These concepts are further described below in the Detailed Description. This Summary is not intended to identify key features or essential features of the claimed subject matter, nor is it intended to be used to limit the scope of the claimed subject matter.

The description generally relates to techniques for protecting data. One example includes a computer-implemented method that can include, by a processing unit, sending, to an interposer, a request to perform a write operation to write data to a storage device. The method can also include, by a processing unit, receiving, from the interposer, an initialization value for the write operation. The method can also include, by a processing unit, performing data at rest encryption on the data using the initialization value, the data at rest encryption resulting in encrypted data. The method can also include, by a processing unit, sending the encrypted data to the interposer, where the interposer writes the encrypted data to the storage device.

Another example entails a system that includes a processor and a storage medium storing instructions. The system can also include an interposer. When executed by the processor, the instructions can cause the system to send, to the interposer, a request to perform a write operation to write data to a storage device. The instructions can also cause the system to receive, from the interposer, an initialization value for the write operation. The instructions can also cause the system to perform data at rest encryption on the data using the initialization value, the data at rest encryption resulting in encrypted data. The instructions can also cause the system to send the encrypted data to the interposer, where the interposer is configured to write the encrypted data to the storage device.

Another example includes a computer-readable storage medium storing executable instructions which, when executed by a processor, cause the processor to perform acts. The acts can include sending, to an interposer, a request to perform a write operation to write data to a storage device. The acts can also include receiving, from the interposer, an initialization value for the write operation. The acts can also include performing data at rest encryption on the data using the initialization value, the data at rest encryption resulting in encrypted data. The acts can also include sending the encrypted data to the interposer, where the interposer writes the encrypted data to the storage device.

The above-listed examples are intended to provide a quick reference to aid the reader and are not intended to define the scope of the concepts described herein.

### BRIEF DESCRIPTION OF THE DRAWINGS

The Detailed Description is described with reference to the accompanying figures. In the figures, the left-most digit(s) of a reference number identifies the figure in which the reference number first appears. The use of similar reference numbers in different instances in the description and the figures may indicate similar or identical items.

FIG. 1 illustrates an example confidential compute architecture consistent with some implementations of the present concepts.

FIG. 2 illustrates an example CPU architecture, consistent with some implementations of the present concepts.

FIGS. 3A-3F illustrate a sequence of operations involving a write command, consistent with some implementations of the present concepts.

FIGS. 4A-4E illustrate a sequence of operations involving a read command, consistent with some implementations of the present concepts.

FIG. 5 illustrates an example of a system in which the disclosed implementations can be performed, consistent with some implementations of the present concepts.

FIG. 6 illustrates an example method or technique for performing a write operation, consistent with some implementations of the disclosed techniques.

FIG. 7 illustrates an example method or technique for performing a read operation, consistent with some implementations of the disclosed techniques.

### DETAILED DESCRIPTION

### OVERVIEW

As noted above, cloud computing offers many benefits to cloud tenants, but comes with potential confidentiality risks. One approach for mitigating confidentiality issues in cloud computing involves offering confidential compute services. Generally, confidential compute services involve encrypting tenant data at rest (e.g., on storage), in transit (e.g., over a bus or network), and while in use (e.g., in memory). In an environment that offers confidential compute, data remains encrypted except for certain operations performed on decrypted data within a trusted execution environment. Thus, malicious actors cannot access sensitive data even when different tenants execute code on the same physical device.

However, data encryption can be quite computationally intensive. Encryption algorithms can involve complex mathematical computations and, in many cases, are performed at very high speed. One high-level approach for reducing the computational burden of encryption operations involves offloading encryption from a central processing unit to another device that performs encryption processing. For instance, some cloud services employ an interposer device that receives link-encrypted data from a central processing unit (CPU), then performs data-at-rest encryption on the data and writes the data to storage device, such as a solid-state drive (SSD).

However, while data at rest encryption with an interposer reduces the computational burden on the CPU, the overall computational burden is still relatively high. This is because the CPU still performs link encryption on the data before sending the data to the interposer. Thus, the data is encrypted twice – once by the CPU using a link encryption algorithm to send the data to the interposer, and then again by the interposer using a data at rest encryption algorithm to send the data to the SSD. The interposer itself may have relatively expensive or complex hardware to implement data at rest encryption processing, and this can result in relatively high manufacturing costs as well as increased power consumption.

An alternative approach could involve data at rest encryption by the hardware in the CPU that services DMA requests. However, this is not necessarily straightforward, as that hardware does not have all the information employed for data at rest encryption. In a multi-tenant environment different keys are used for each tenant, to maintain data security. However, these keys are generally not known to the DMA hardware. Further, some data at rest encryption algorithms rely on these logical block addresses (LBAs) to encrypt and decrypt data, but these logical block addresses are not necessarily known by the DMA hardware.

The disclosed implementations allow for data at rest encryption to be performed by a CPU in a multi-tenant environment that uses an interposer as an intermediary between the CPU and an SSD. The interposer can coordinate transfers of encrypted data between the CPU and the SSD, but the interposer does not necessarily perform data at rest encryption. Instead, the interposer can support link encryption for control data associated with data transfers while the data payloads are encrypted by the CPU. As a consequence, redundant encryption processing is reduced or eliminated while simplifying and reducing the manufacturing cost of the interposer as well as power consumption.

### TERMINOLOGY

The term “processing unit,” as used herein, refers to a hardware circuit that can be configured via executable instructions to perform functions such as computation and data transfers. For instance, a CPU is an example of a general-purpose processing unit that can be programmed to perform a wide range of functions to implement applications, operating systems, hypervisors, virtual machines, etc. A graphics processing unit is another example of a processing unit that is typically specialized for more limited functions, such as performing parallel operations on data for rendering graphics or for machine learning computations. A neural processing unit is another example of a processing unit that is specialized for machine learning operations, such as inference operations involving convolution or pooling.

The term “interposer,” as used herein, refers to a hardware component, such as an application-specific integrated circuit, that acts as an intermediary between a processing unit and a storage device, such as an SSD. An interposer can have circuitry to support data transfers over a bus, and can also have circuitry to support link encryption. Interposers can also isolate virtual machines so that they cannot access the same storage addresses on a storage device.

The term “data at rest” encryption refers to encryption on data for storage on a physical device, such as an SSD. Data at rest encryption can protect data when the storage device is physically compromised, e.g., stolen. The term “link encryption” refers to encryption on data for transfer over a bus or network to another device. For example, a device can retrieve unencrypted data from memory, set up link encryption with another device, encrypt the data according to the link encryption algorithm, and then send the link encrypted data to the other device. Data in use encryption refers to data that is in main memory of a computing device in encrypted form, e.g., to protect that data from being compromised during use.

The terms “initialization value” and “initialization data” refer to data used to initialize a cryptographic operation, such as an encryption or decryption operations using Advanced Encryption Standard (AES). AES provides various specific algorithms, such as counter mode or “AES-CTR” and Galois/Counter mode “AES-GCM” for link encryption. AES also provides XEX-based Tweaked CodeBook Mode with Ciphertext Stealing (XTS) mode, or “AES-XTS” for data at rest encryption. The terms “initialization value” and “initialization data” encompass AES-XTS tweak values, AES-GCM initialization vectors, or other values that can be used to encrypt or decrypt data. In some cases, such as AEX-XTS, initialization values can be determined as a function of a storage address and an encryption key.

The terms “data payload” and “payload” refer to data being committed to storage during a write operation or retrieved from storage during a read operation. For instance, a payload for a given I/O operation can include tenant data that is encrypted by a processing unit using a data at rest encryption algorithm, such as AES-XTS. The term “control data” refers to data communicated with a payload to instruct a given device, such as an interposer or storage device, to perform operations on the payload. Thus, the term “control data” encompasses Peripheral Component Interconnect Express (PCIe) or Non-Volatile Memory Express (NVMe) commands that instruct an interposer and/or SSD to store a payload on a storage device or retrieve a payload from the storage device.

### EXAMPLE CONFIDENTIAL COMPUTE ARCHITECTURE

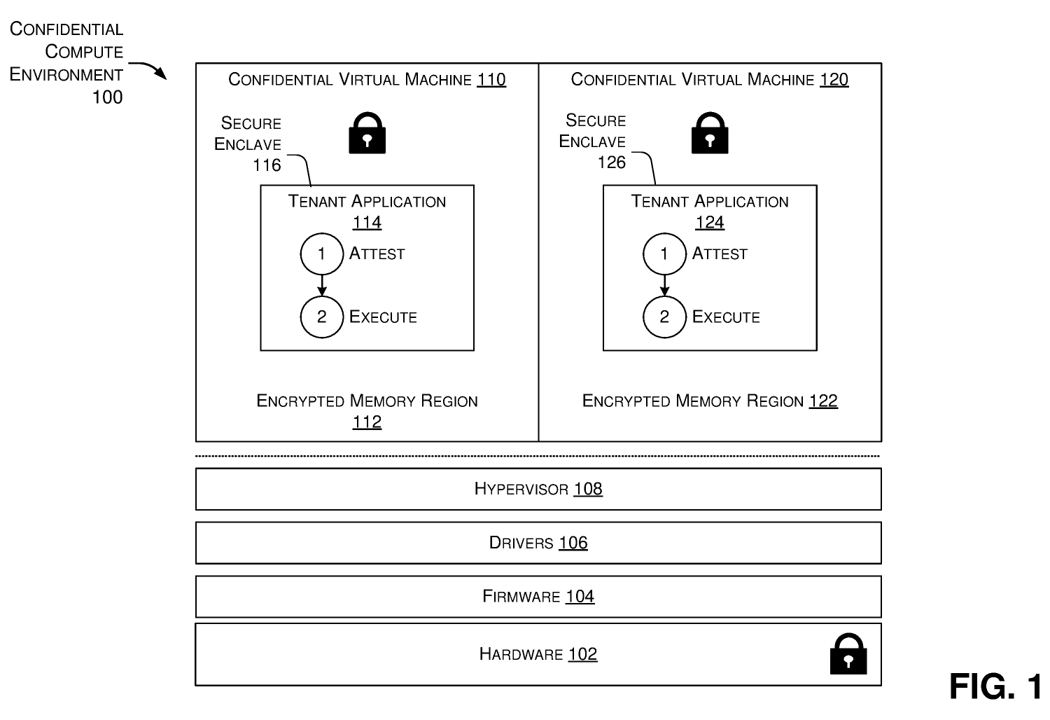

FIG. 1 shows a confidential compute environment 100 with hardware 102, such as a central processing unit, main memory, an interposer, a storage device such an SSD, I/O devices such as network adapters, input devices, output devices, etc. Firmware 104 can initialize the hardware during bootup, and after bootup can provide limited functionality such as managing a system clock or performing power management operations. For example, the firmware can be implemented using Unified Extensible Firmware Interface (UEFI) and/or Basic Input/Output System (BIOS) technologies. During bootup, firmware 104 can initialize and configure the hardware using drivers 106, and then transfer control to a hypervisor 108.

Hypervisor 108 can utilize drivers 106 to control hardware 102. Note that the hypervisor may have its own drivers that are used at runtime and are different than the drivers employed by the firmware 104. The hypervisor can be a Type 1 (e.g., “bare metal”) hypervisor that runs directly on hardware 102 or can be a Type 2 (e.g., “hosted”) hypervisor that executes on top of an underlying host operating system that manages the hardware.

Hypervisor 108 can provide a confidential virtual machine 110 with an encrypted memory region 112 to a tenant application 114, and a confidential virtual machine 120 with an encrypted memory region 122 to a tenant application 124. The encrypted memory regions provide for data in use encryption of sensitive data when processed by the respective tenant applications. Tenant application 114 can execute in a secure enclave 116 where the tenant application can perform an attestation process that allows the tenant application to execute on decrypted data within secure enclave 116. Likewise, tenant application 124 can execute in a secure enclave 126 where the tenant application can perform an attestation process that allows the tenant application to execute on decrypted data within secure enclave 126. In further implementations, additional confidential virtual machines are provided, each executing additional instances of tenant applications in additional secure enclaves. Secure enclaves can be implemented using technologies such as Intel® Software Guard Extensions (Intel® SGX), Intel Trusted Domain Extensions (Intel® TDX) or AMD® Secure Encrypted Virtualization (AMD® SEV), ARM® Trustzone, ARM® Confidential Compute Architecture, Trusted Platform Modules (TPMs), etc.

Hypervisor 108 can provide virtualized hardware to confidential virtual machine 110 and confidential virtual machine 120. For instance, the hypervisor can provide virtualized CPU, virtualized memory, virtualized storage, virtualized network, etc. With respect to virtualized storage specifically, the hypervisor can provide each of the confidential virtual machines with an abstraction of an SSD with virtual storage addresses. As described more below, an interposer can map the virtual storage addresses to corresponding LBAs on an SSD.

### EXAMPLE CPU ARCHITECTURE

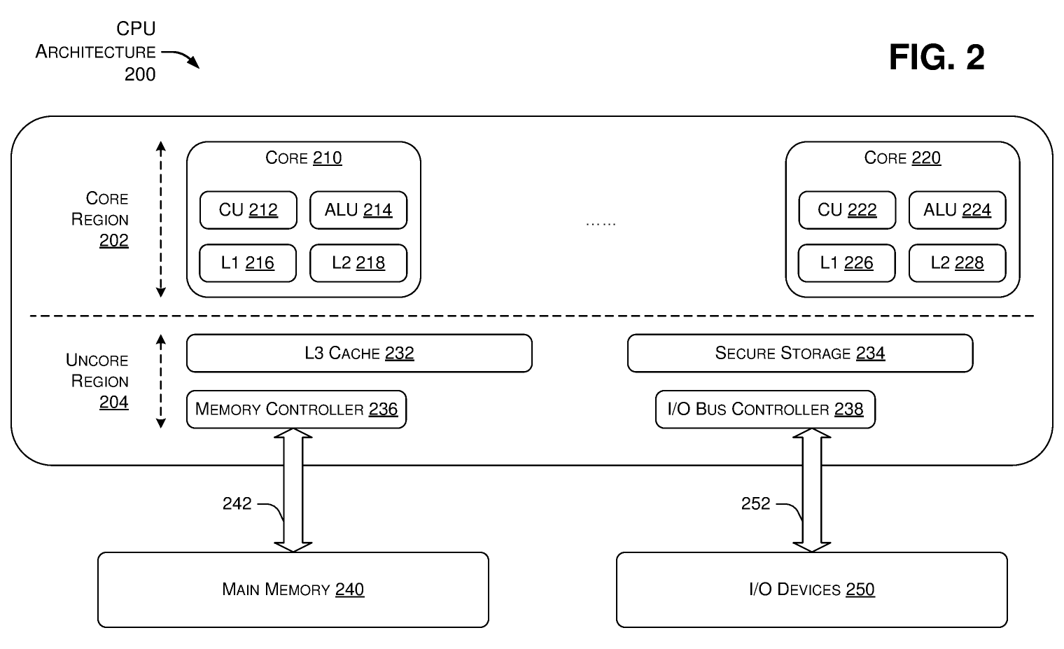

FIG. 2 shows an example CPU architecture 200 with a core region 202 and an uncore region 204. The core includes region includes core 210 and core 220. Core 210 can include a control unit or CU 212, an arithmetic logic unit or ALU 214, an L1 cache 216, and an L2 cache 218. Core 220 includes a CU 222, an ALU 224, an L1 cache 226, and an L2 cache 228. The respective CUs can be responsible for fetching instructions from memory, decoding the instructions into micro-operations, synchronizing operations within its respective core according to a system clock, managing data flow within the respective core, etc. The respective ALUs can perform arithmetic operations such as addition and subtraction, logical operations such as AND, OR, XOR, NOT, bitwise operations, shift operations, comparisons, etc. The respective L1 caches can be very fast memory, small memory regions (e.g., 16-128 kilobytes) that take only a few (e.g., 1-3) CPU clock cycles to access. The respective L2 caches can be similar to the L1 caches but can be somewhat larger (e.g., 256 kilobytes to several megabytes) and can take somewhat longer to access, e.g., 3-10 CPU clock cycles. Additional cores with additional CUs, ALUs, and L1/L2 caches can also be provided.

The uncore region 204 includes an L3 cache 232, secure storage 234, a memory controller 236, and an I/O bus controller 238. The L3 cache serves a similar function to the L1 and L2 caches but can be much larger (e.g., 4-64 megabytes) and slower to access (10-20 CPU clock cycles). The memory controller communicates data to/from main memory 240 over memory bus 242 (double arrow toward memory) and the I/O bus controller communicates data to/from I/O devices 250 over I/O bus 252 (double arrow toward I/O devices). For instance, the memory bus can be a double data rate (DDR) memory bus and the I/O bus can be a PCIe bus.

Secure storage 234 can include one or more secure registers, volatile memory, or non-volatile memory. The secure storage can be used to store various encryption keys. For instance, the following describes implementations that employ AES-XTS for data at rest encryption, where two keys are involved. Each tenant can have a separate pair of keys. For instance, each tenant can be assigned a separate PCIe requester ID (RID), and the encryption keys can be indexed in the secure storage by the PCIe RID.

In some implementations, the PCIe RID is used to map memory addresses for each tenant. This approach allows different PCIe RID’s for different tenant VMs to provide a level of hardware isolation. For instance, the PCIe RID of a tenant can have a corresponding address translation table stored in memory. Each tenant can be restricted to accessing memory regions assigned to that tenant in the translation table. Thus, the PCIe RID of the tenant serves as an index to identify the memory regions accessible to each tenant. The PCIe RID can also be employed to provide virtualized I/O access (e.g., to an SSD) for each tenant, where each tenant has access to a tenant-specific set of LBA’s on the SSD that correspond to its RID.

Secure storage 234 can also be employed to store initialization data for each input/output operation to a given I/O device. For example, when AES-XTS is employed for data at rest encryption, a key pair can be employed for each tenant, where the first key is used for encryption/decryption and the second key is combined with the LBA of a given I/O operation to generate initialization data (a tweak value). Thus, the number of initialization data values that are be stored can be a multiple of the number of supported keys. For instance, to support 16 outstanding I/Os per tenant, secure storage may have storage regions for initialization data or tweak values for 16 times the number of tenant key pairs. Storage 234 can also be employed to store a block offset for a given I/O operation, as discussed more below.

### EXAMPLE COMMUNICATION SEQUENCE FOR WRITE OPERATION

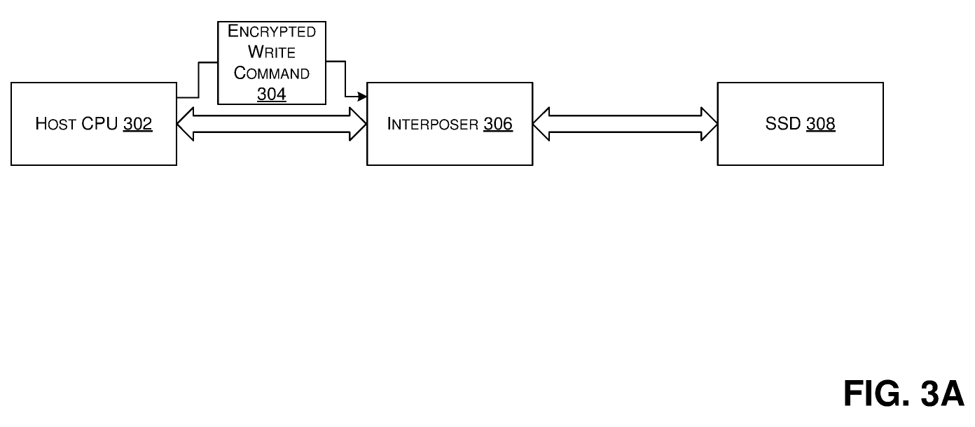

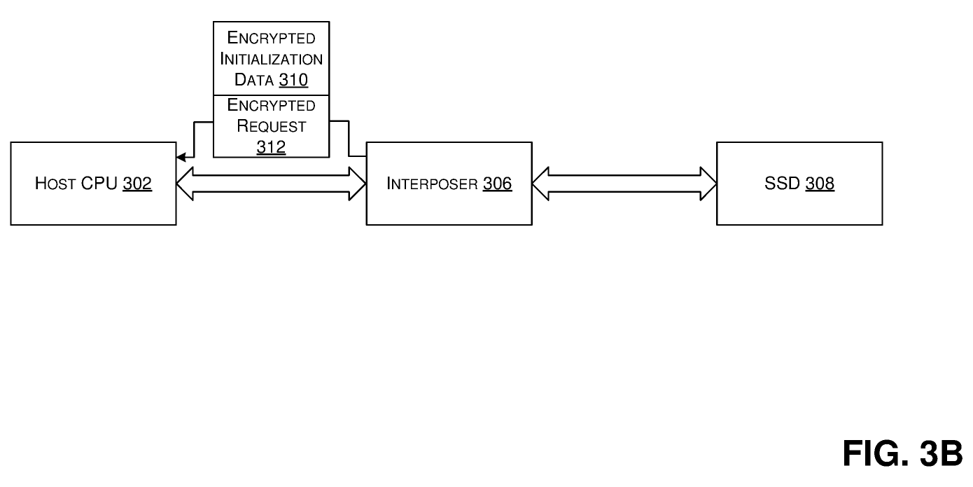

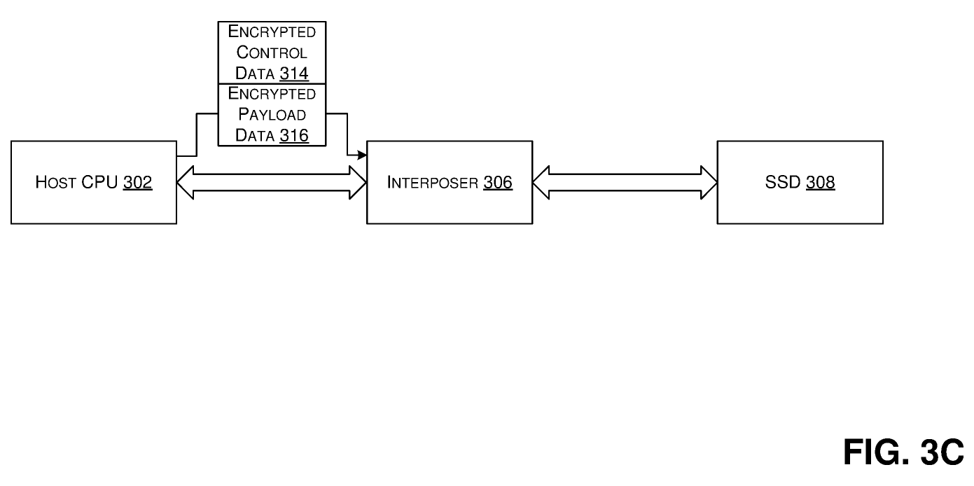

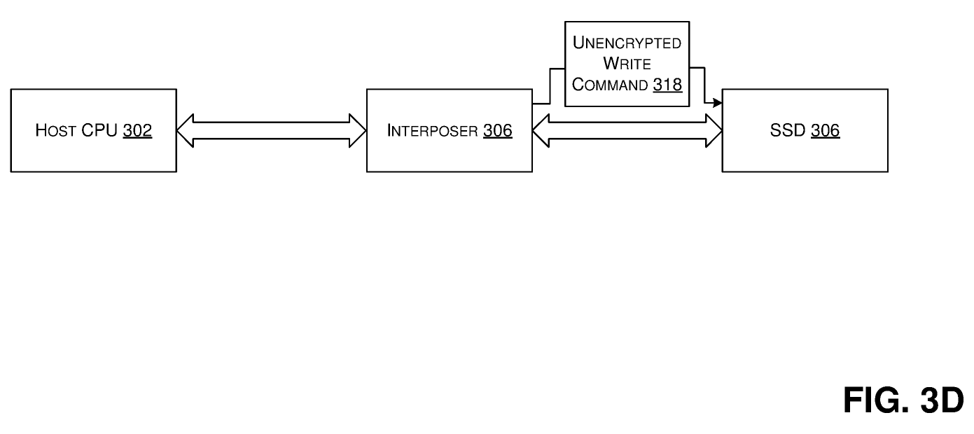

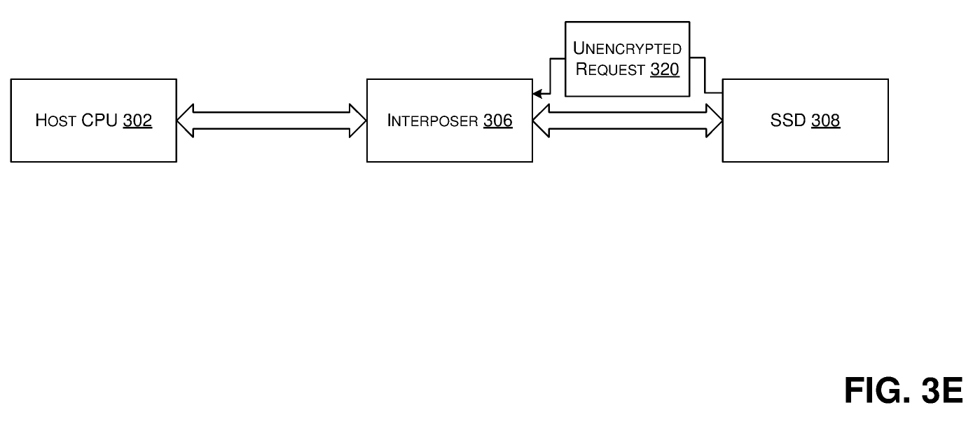

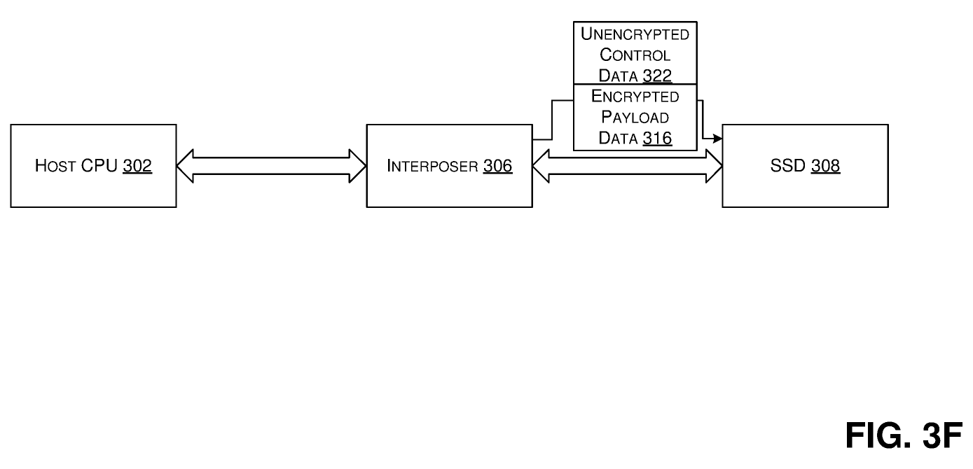

FIGS. 3A-3F show an example of communications employed for a CPU to perform a write operation of encrypted data to an SSD via an interposer. Note that the following merely describes one example of how a CPU, interposer, and SSD can interact, and the disclosed concepts can be employed using different sequences of communications by the CPU, interposer, and/or SSD than those shown below. In the description below, each of the communications can conform to a protocol for storage I/O, such as NVMe.

In FIG. 3A, host CPU 302 sends an encrypted write command 304 to interposer 306 for data to be written to an SSD 308. The host CPU can have a hardware configuration such as CPU architecture 200, and can be employed to provide confidential compute environment 100. For instance, a driver executing on the host CPU can create a command to write data to the SSD and send the write command to the interposer. For security, that command can be encrypted. For instance, the write command can be encrypted using link encryption, such as AES-GCM. In some implementations, the write command can specify a virtual storage address for a virtual storage device provided to a particular tenant application that is requesting to write the data to storage. The write command can include an NVMe command identifier, an opcode (e.g., write), etc.

In FIG. 3B, the interposer 306 sends back encrypted initialization data 310 and encrypted request 312 to the CPU 302. For instance, the initialization data and request can be encrypted using link encryption such as AES-GCM. The initialization data can include initialization data for data at rest encryption. For instance, the initialization data can include a tweak value for AES-XTS. For instance, in some implementations, the interposer maps the virtual storage address received from the host CPU to one or more LBAs where the data will be stored on the SSD, and then determines the tweak value(s) based on the LBAs. The encrypted request can identify the data that is being requested from the host CPU to be written to the SSD, and can include the NVMe command identifier received previously. Prior to sending back the encrypted initialization data and the encrypted request, the interposer can take certain steps to prepare for receiving the data, such as ensuring that the LBA where the data is written on the SSD is ready and that there is sufficient space for the data to be written.

In FIG. 3C, the CPU 302 sends encrypted control data 314 and encrypted payload data 316 to the interposer 306. The encrypted control data can be encrypted using link encryption such as AES-GCM. For example, the encrypted control data can specify information such as a memory address in main memory where the data is located, and a transfer size of the data payload. The interposer can then retrieve the encrypted payload data from the specified location in memory, after the CPU has encrypted the payload data using data at rest encryption such as AES-XTS. The CPU may have encrypted the payload data using the initialization data 310 and one or more encryption keys stored on the CPU. The encryption key(s) can be associated with the particular tenant that is requesting to write the data to storage.

In FIG. 3D, the interposer 306 sends an unencrypted write command 318 to the SSD 308. For instance, the interposer can determine the unencrypted write command by decrypting the encrypted control data 314 received from the CPU. The unencrypted write command can include a command identifier and an opcode indicating the operation is a write operation. The unencrypted write command can specify one or more LBAs where the decrypted payload data will be written. The unencrypted write command can also specify the address in main memory where the SSD can retrieve the encrypted data payload, as well as the size of the data to be transferred.

In FIG. 3E, the SSD 308 sends an unencrypted request 320 to the interposer 306. In some implementations, the unencrypted request can include the command identifier received via the unencrypted write command 318, the address of the data to be received, the size of the data to be transferred from the interposer to the SSD, etc.

In FIG. 3F, the interposer 306 sends unencrypted control data 322 and the encrypted payload data 316 to the SSD 308. The SSD can write the data to the LBA specified previously. The SSD can store the encrypted payload data for subsequent retrieval via a read operation, as discussed more below.

### EXAMPLE COMMUNICATION SEQUENCE FOR READ OPERATION

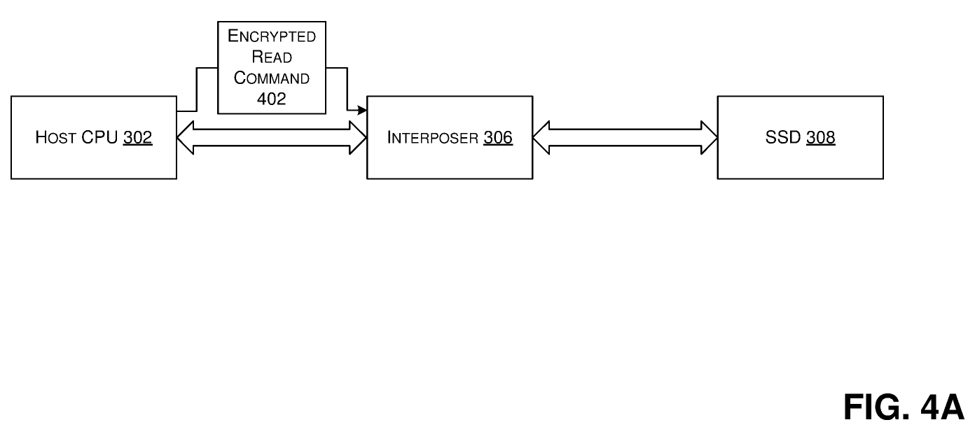

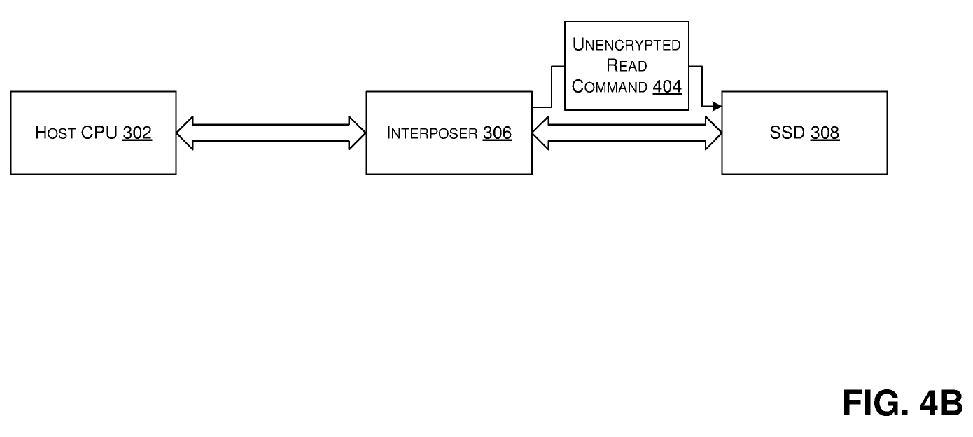

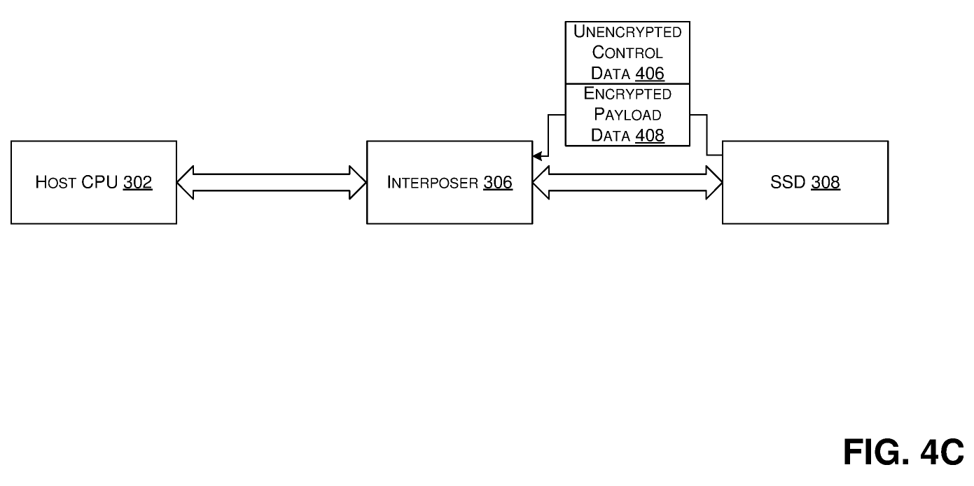

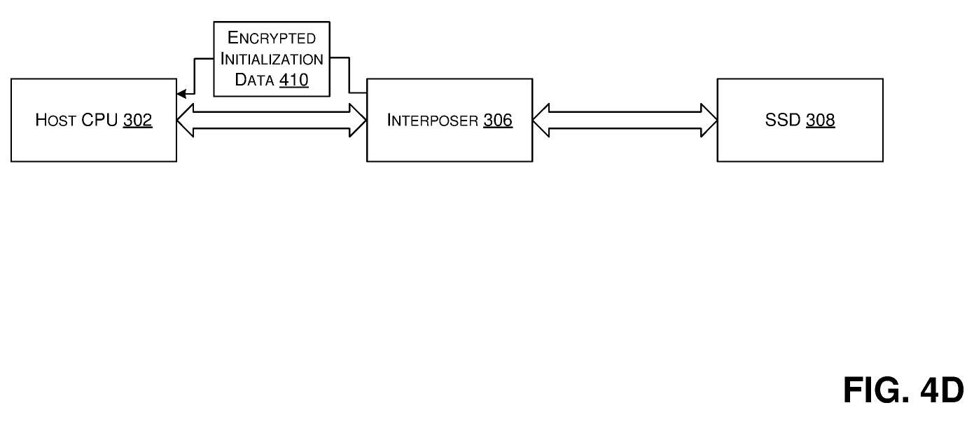

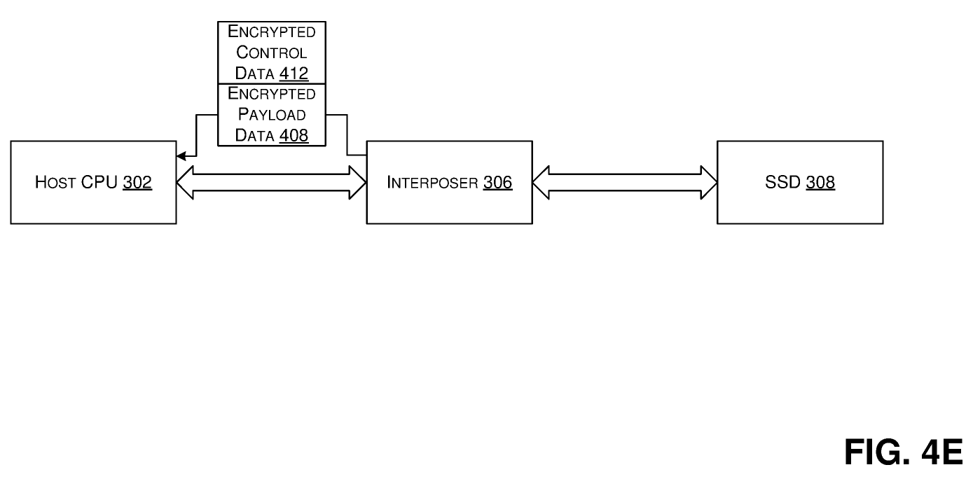

FIGS. 4A-4E show an example of communications employed for a CPU to perform a read operation of encrypted data from an SSD via an interposer. Note that the following merely describes one example of how a CPU, interposer, and SSD can interact, and the disclosed concepts can be employed using different sequences of communications by the CPU, interposer, and/or SSD than those shown below. In the description below, each of the communications can conform to a protocol for storage I/O, such as NVMe.

In FIG. 4A, host CPU 302 sends an encrypted read command 402 to the interposer 306. For instance, a driver executing on the host CPU can create an appropriate command and send it to the interposer. For instance, the command can be encrypted using link encryption, such as Advanced Encryption Standard (AES) in Galois/Counter mode (GCM), or “AES-GCM.” In some implementations, the read command can specify a virtual storage address for a virtual storage device provided to a particular tenant application that is requesting the data from storage. The read command can specify an address in main memory where the data should be transferred to and the size of the data transfer, and can include an opcode indicating the command is a read operation and a command identifier.

In FIG. 4B, the interposer 306 sends an unencrypted read command 404 to the SSD 308. For instance, the interposer can map the virtual storage address received from the CPU to one or more LBAs on the SSD where the requested data is stored. Then, the interposer can configure the unencrypted read command to retrieve data from those LBAs. The unencrypted read command can specify an amount of data to transfer from the SSD to the interposer.

In FIG. 4C, the SSD 308 sends unencrypted control data 406 and encrypted payload data 408 to the interposer 306. Recall that the encrypted payload data was previously encrypted by the host CPU 302. The control data can include the command identifier of the read operation.

In FIG. 4D, the interposer 306 sends encrypted initialization data 410 to the host CPU 302. The initialization data can be the same as initialization data 310. For instance, the initialization data can include one or more tweak values that the interposer determined from the one or more LBAs where the encrypted payload data was stored on the SSD 308.

In FIG. 4E, the interposer sends encrypted control data 412 to the host CPU 302 with the encrypted payload data 408. The CPU can then decrypt the encrypted payload data using the initialization data 410 and one or more encryption keys, e.g., for the tenant application that requested to read the data from storage.

### FURTHER IMPLEMENTATION DETAILS

CPU architecture 200 can provide a mechanism to update the initialization values received from a downstream hardware component, such as interposer 306 or SSD 308. For instance, host CPU 302 can receive a PCIe Memory Write from the interposer 306 or SSD 308 to a defined address range in the main memory 240 of the CPU. The interposer or SSD could write the desired initialization data values just before initiating a direct memory access (DMA) transfer for an I/O operation and could free up that location for re-use as soon as the DMA transfer is completed.

CPU architecture 200 can also provide a mechanism using PCIe to identify, on a per transaction layer packet (TLP) basis, which keys and initialization data values should be used for cryptographic operations on that packet’s payload. The identification can include the PCIe function number (aka PCIe RID) corresponding to a particular virtual machine, and some bits of a PCIe transaction tag corresponding to individual I/O operations associated with that virtual machine. For example, if 16 outstanding I/O operations are supported for each virtual machine, the upper 4 bits of the transaction tag can be used as I/O operation identifiers. In such an implementation, the PCIe RID can be used to select the tenant-specific encryption keys associated with a given virtual machine for any read or write operation, and the tag bits, in conjunction with the PCIe RID, can be employed to select the initialization data for a given I/O operation.

As also noted above, CPU architecture 200 can provide storage for a block offset in secure storage 234. In many cases, memory pages can have a size such as 4 kilobytes, whereas I/O operations can read or write blocks of data that are larger than the memory page size. For instance, a read or write operation may use I/O blocks of 512 kilobytes, 1 or 2 megabytes, etc. Thus, multiple memory pages may fit in a single I/O block. In a simple case, an I/O transfer data would start at block offset 0 within a given page of memory (e.g., 4 kilobytes) for a given DMA operation. If so, the data’s offset within that page would not be its offset within the I/O data block, in other words the memory page and I/O block would be aligned. However, other cases can occur. In general, the I/O block can start on any 4 byte boundary within the page. Further, the I/O block can cross into another page. Thus, in some implementations, a block offset field can be stored in secure storage 234 and added to the DMA address to compute the offset of a data location within the block being transferred in a given I/O operation. This block offset storage could have the same number of entries as the initialization data storage mentioned above (e.g., to support 16 I/O operations per VM) and could be indexed the same way. The block offset storage could also be written from the downstream component with a similar operation, e.g., the SSD 308 or interposer 306 could transfer, to the host CPU 302, the offset to use for a given data transfer.

CPU architecture 200 can also support a link encryption mechanism such that the payload portion of a TLP is encrypted with a data-at-rest algorithm such as AES-XTS, while the rest is encrypted with a link encryption algorithm such as AES-GCM. The parameters from the AES-XTS algorithm are described previously, e.g., encryption keys can be specific to each virtual machine while tweak values can be derived based on the LBA on the SSD for a given data transfer. For the AES-GCM encryption, the CPU and interposer can randomly generate an initialization vector and use a shared symmetric key for encryption and decryption, e.g., of command data associated with a given data transfer.

Further implementations can also provide data integrity operations. For instance, in some applications, a cyclic redundancy check (CRC) can be added to each disk sector to ensure the integrity of the data on that sector. For instance, each block on SSD 308 can include one or more sectors that store 512 bytes of data, 4 kilobytes of data, etc. Support for a CRC could be provided as follows. Each initialization data value could be paired with storage for a CRC on the host CPU 302, e.g., in secure storage 234. The CRC can be reset whenever the initialization data for a given data transfer is written. When the payload of a TLP is encrypted or decrypted using initialization data for a given transfer, the corresponding CRC can be updated by using the decrypted plaintext as additional input. This way, the CRC is computed over all plaintext associated with that initialization data. Since the CRC is order dependent, the plaintext is presented to the CRC logic in the correct order for the check to succeed. During a write operation, the CPU can send the CRC to the SSD, which can confirm the CRC prior to writing the data to physical storage. During a read operation, the CPU can compute the CRC over the received data, and compare the computed CRC with the CRC received from the SSD to confirm integrity of the data being read. If the CRC is correct, the host CPU can load the data payload into main memory. Otherwise, the host CPU can repeat the read operation until the CRC check succeeds, or else terminate the read operation and generate an exception.

In addition, note that some encryption algorithms operate on defined block sizes. For instance, AES encryption can operate on 16 byte blocks. Thus, some implementations will access the I/O read and write data in 16 byte chunks aligned to 16 byte boundaries within the logical blocks on SSD 308. However, DMA accesses do not necessarily operate on these 16 byte boundaries. Since requests can be issued in any order and responses to them can arrive in any order, one solution would be for the entire logical block to be buffered before encryption or decryption can begin.

Another efficient implementation could place restrictions on the SSD to make the implementation simpler and more efficient. For instance, SSD 308 can be configured to issue requests that start and end on 16 byte boundaries within a given sector on the SSD. One exception is that the sector could be spread over two physical pages, which may prevent aligning a given request on a 16 byte boundary. In that case, buffering of up to 12 bytes may be employed to complete a 16 byte block for encryption. Some implementations may take further steps to ensure that this buffering is short lived and that all 16 bytes of the block become available to the encryption/decryption logic quickly.

In the case where CRC generation is also performed, some implementations can ensure that payload data arrives in order at the logic that computes the CRC. One way to achieve this is to issue only one TLP at a time, for a given I/O. Other implementations can employ sequence numbers or other techniques to ensure in-order arrival of payload data for CRC computation.

### EXAMPLE SYSTEM

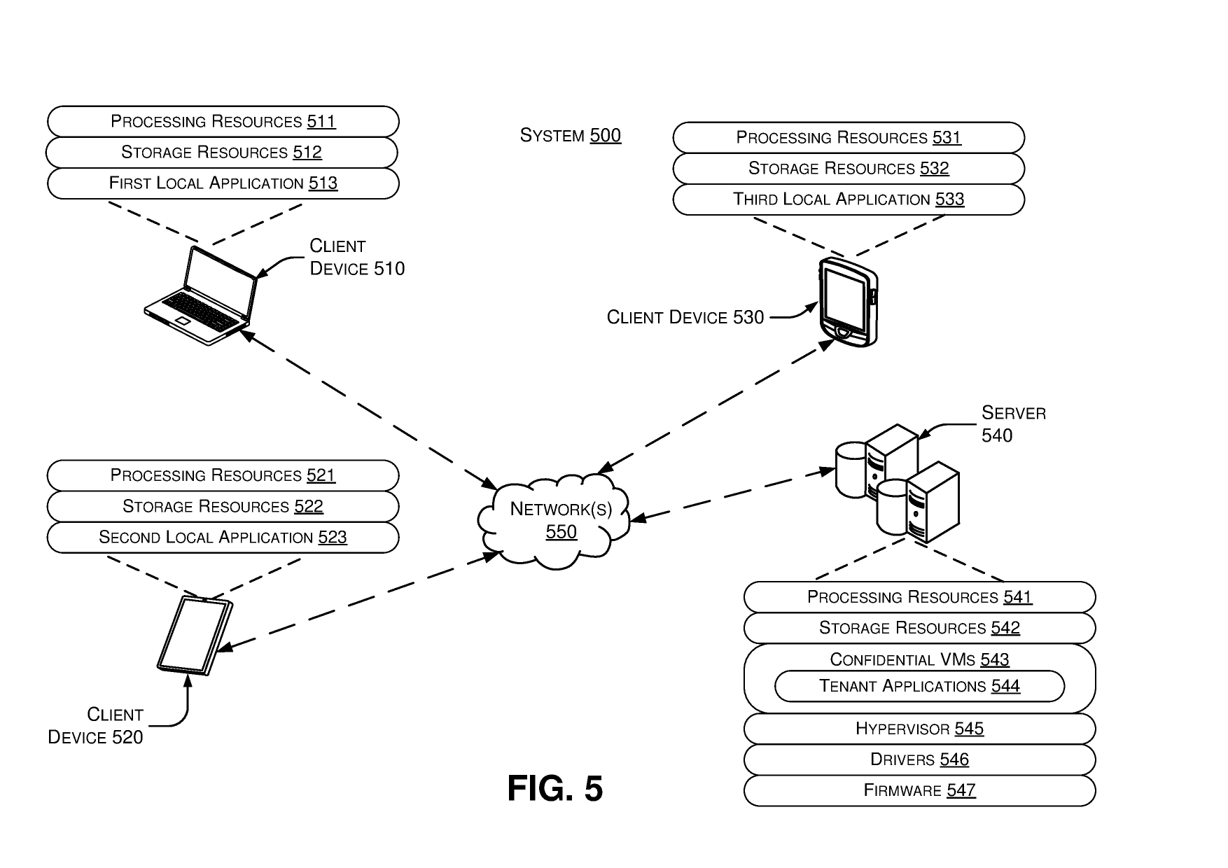

The present implementations can be performed in various scenarios on various devices. FIG. 5 shows an example system 500 in which the present implementations can be employed, as discussed more below.

As shown in FIG. 5, system 500 includes a client device 510, a client device 520, a client device 530, and a server 540, connected by one or more network(s) 550. Note that the client devices can be embodied as mobile devices such as smart phones or tablets, as well as stationary devices such as desktops, etc. Likewise, the servers can be implemented using various types of computing devices. In some cases, any of the devices shown in FIG. 5, but particularly the servers, can be implemented in data centers, server farms, etc.

Client device 510 can have processing resources 511 and storage resources 512, client device 520 can have processing resources 521 and storage resources 522, client device 530 can have processing resources 531 and storage resources 532, and server 540 can have processing resources 541 and storage resources 542. Each of these devices may also have various modules that function using the processing and storage resources to perform the techniques discussed herein. The storage resources can include both persistent storage resources, such as magnetic or solid-state drives, and volatile storage, such as one or more random-access memory devices. In some cases, the modules are provided as executable instructions that are stored on persistent storage devices, loaded into the random-access memory devices, and read from the random-access memory by the processing resources for execution.

Client device 510 can include a first local application 513, client device 520 can include a second local application 523, and client device 530 can include a third local application 533. Server 540 can implement confidential compute environment 100 shown in FIG. 1. For instance, server 540 can include confidential virtual machines 543 executing tenant applications 544, hypervisor 545, drivers 546, and firmware 547, which can function as described above with respect to FIG. 1. Processing resources 541 can include a host CPU according to CPU architecture 200 as well as an interposer as described previously. Storage resources 542 can include one or more SSDs as described previously.

Each of the local applications on the respective client devices can correspond to a particular tenant application executing in a respective confidential virtual machine on server 540. The respective client devices can send sensitive data to the server 540 for processing in encrypted form, e.g., using end-to-end encryption over network(s) 550 via a protocol such as Secure Sockets Layer (SSL) or Transport Layer Security (TLS). The server 540 can process the tenant data in encrypted form at all times except for within a respective secure enclave in a corresponding virtual machine.

As noted above, secure storage 234 on the host CPU 302 can be employed to store encryption keys as well as initialization data, such as AES-XTS tweak values. Now, assume as before that 16 concurrent I/O operations are supported per tenant. Assuming three tenant applications, this means that there is sufficient storage for at least six encryption keys in the secure storage – two keys for the first tenant, two keys for the second tenant, and two keys for the third tenant. Furthermore, there is sufficient storage for at least 48 tweak values, with 16 per each tenant application. Those skilled in the art will recognize that other implementations may support different numbers of tenant applications, and the size of the secure storage for the encryption keys would change accordingly. Likewise, those skilled in the art will recognize that the number of concurrent I/O operations supported could change, and the size of the secure storage for the initialization data values would change accordingly.

### EXAMPLE METHOD FOR WRITE OPERATION

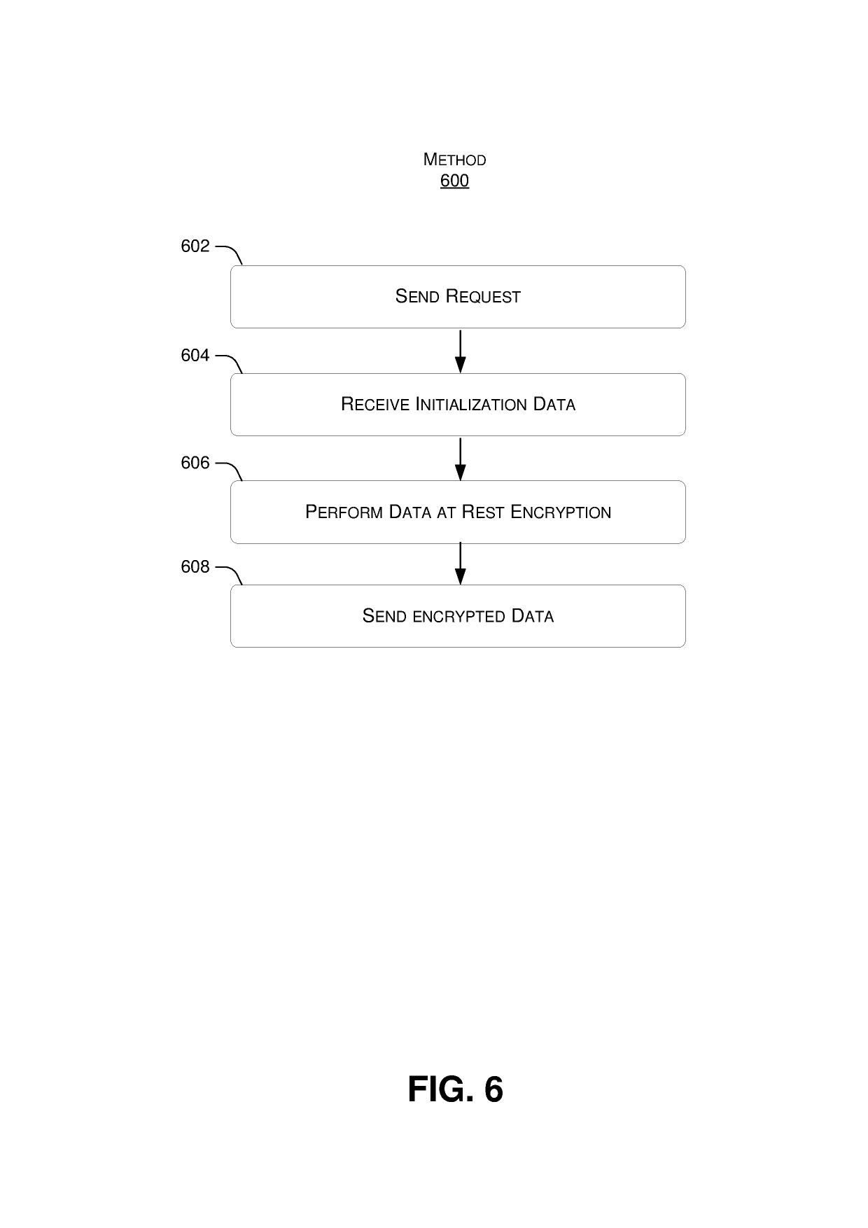

FIG. 6 illustrates an example computer-implemented method 600, consistent with some implementations of the present concepts. Computer-implemented method 600 can be performed by a processing unit, such as a CPU, in communication with an interposer and a storage device, such as an SSD.

Method 600 begins at block 602, where a request is sent from a processing unit to an interposer to perform a write operation to write data to a storage device, such as an SSD. For example, the request can include an encrypted write command that is encrypted using a link encryption algorithm. The request can specify a virtual storage address where the data is to be written to a virtual storage device.

Method 600 continues at block 604, where an initialization value is received. For instance, the processing unit can receive a tweak value from the interposer, where the interposer determines the tweak value based on an LBA where the data will be written to the storage device. The tweak value can be determined by the interposer using a function that is based on the LBA and an encryption key for a data at rest encryption algorithm, such as AES-XTS.

Method 600 continues at block 606, where data at rest encryption is performed on the write data to be written to storage. For instance, the processing unit can perform data at rest encryption on the write data using the initialization value and another encryption key corresponding to a tenant requesting to write data to storage. For instance, the key employed at block 606 can be associated with the key used at block 604 to determine the tweak value.

Method continues at block 608, where the encrypted write data is sent from the processing unit to the interposer. For instance, the encrypted write data can be sent to the interposer as an encrypted data payload that has been encrypted using data at rest encryption. The encrypted data can be sent using encrypted control data that is encrypted using link encryption. The interposer can then write the encrypted write data payload to the storage device at the specified LBA(s).

### EXAMPLE METHOD FOR READ OPERATION

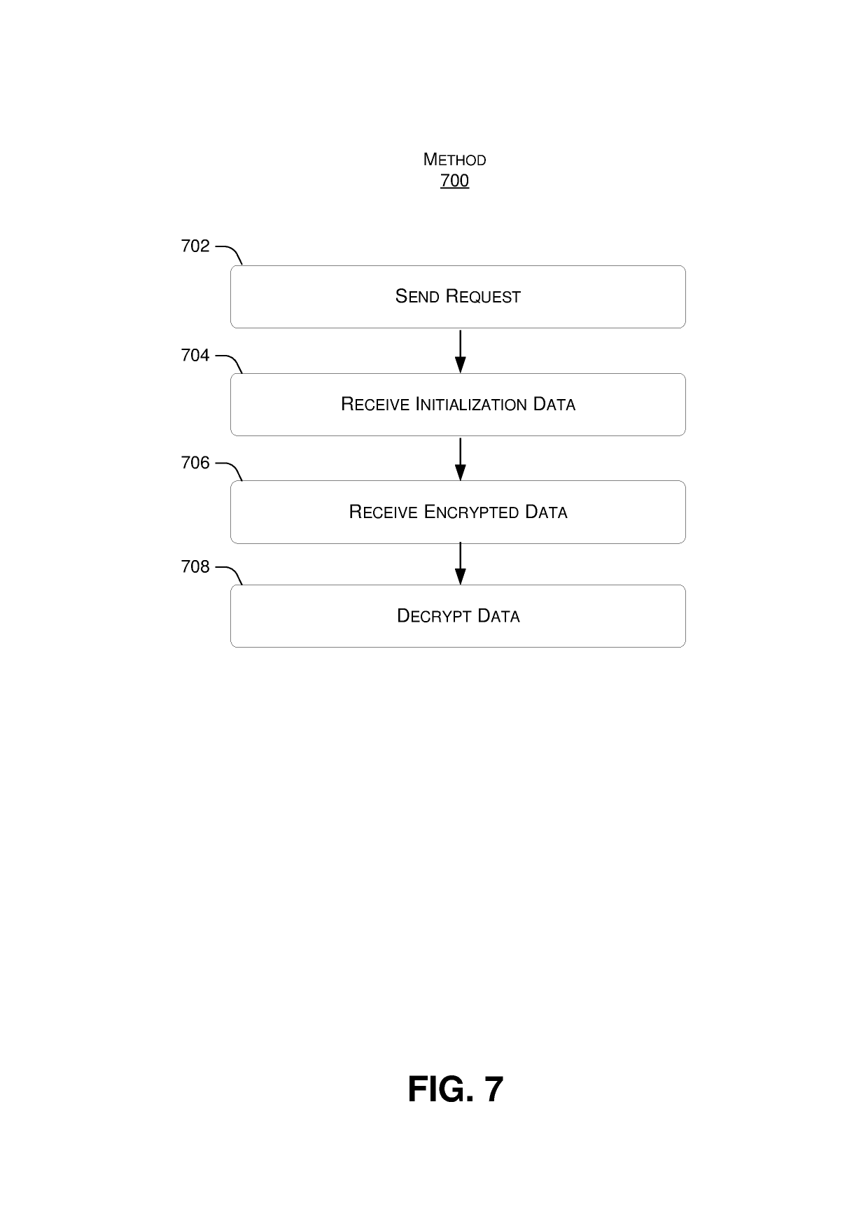

FIG. 7 illustrates an example computer-implemented method 700, consistent with some implementations of the present concepts. Computer-implemented method 700 can be performed by a processing unit, such as a CPU, in communication with an interposer and a storage device, such as an SSD.

Method 700 begins at block 702, where a request is sent from a processing unit to an interposer to perform a read operation to read data from a storage device. For example, the request can include an encrypted read command that is encrypted using a link encryption algorithm. The request can specify a virtual storage address where the data is to be read from a virtual storage device.

Method 700 continues at block 704, where an initialization value is received. For instance, the processing unit can receive a tweak value from the interposer, where the interposer determines the tweak value based on an LBA where the data will be read from the storage device. The tweak value can be determined by the interposer using a function that is based on the LBA and an encryption key for a data at rest encryption algorithm, such as AES-XTS.

Method 700 continues at block 706, where encrypted data is received. For instance, the SSD can retrieve data that was previously encrypted by the CPU using data at rest encryption using the initialization value and another encryption key corresponding to a tenant requesting to read data from storage. For instance, the key employed at block 706 can be associated with the key used at block 704 to determine the tweak value. The SSD can provide the data to the interposer, which then sends the data to the processing unit.

Method continues at block 708, where decryption is performed. For instance, the processing unit can employ data at rest decryption to decrypt the data using the initialization value and the associated encryption key for the tenant requesting to read the data from the storage device.

### TECHNICAL EFFECT

The use of an interposer in confidential compute environments can have many benefits. For instance, interposers can offload cryptographic operations from a CPU, and can also help ensure data isolation for virtualized storage provided to different virtual machines executing on the CPU. However, performing data at rest encryption using an interposer generally involves redundant cryptographic operations, because the CPU will perform link encryption on data that is sent to the interposer and then the interposer will decrypt this data using a link encryption algorithm and then re-encrypt the data using a data at rest encryption algorithm. As a consequence, the interposer is generally manufactured with circuitry for data at rest encryption, which increases manufacturing costs. Furthermore, the redundant cryptographic operations can increase power consumption.

The disclosed techniques offer an approach where an interposer can still be leveraged for storage isolation among virtual machines, while reducing the manufacturing cost of the interposer and also the power consumption involved in providing confidential compute services to tenant applications. By performing data at rest encryption on a host CPU, the interposer can be simplified to eliminate circuity employed for data at rest encryption. Furthermore, redundant cryptographic operations can be reduced or eliminated. Because the data payloads transferred to/from the CPU are encrypted using data at rest encryption, the interposer only needs to encrypt/decrypt associated control data using link encryption instead of the entire data payload.

Furthermore, the disclosed techniques can be implemented using relatively minor, low-cost modifications to existing CPU architectures. By providing a relatively small secure memory region for storage of encryption keys, initialization data, etc., the CPU can support data at rest encryption for confidential compute services. The relatively small increased manufacturing and power consumption cost on the CPU is more than offset by the corresponding savings by simplification of the interposer, while still leveraging the interposer for storage address isolation and handling of unencrypted communications with a physical storage device.

### DEVICE IMPLEMENTATIONS

The examples and figures introduced above show various types of communication devices. As also noted, not all device implementations can be illustrated, and other device implementations should be apparent to the skilled artisan from the description above and below. The term “device”, "computer,” "computing device," “client device,” “communication device,” and/or “server device” as used herein can mean any type of device that has some amount of hardware processing capability and/or hardware storage/memory capability. Processing capability can be provided by one or more hardware processors (e.g., hardware processing units/cores) that can execute computer-readable instructions to provide functionality. Computer-readable instructions and/or data can be stored on storage, such as storage/memory and or the datastore and, when executed, can cause a processor to perform acts. The term “system” as used herein can refer to a single device, multiple devices, etc.

Storage resources can be internal or external to the respective devices with which they are associated. The storage resources can include any one or more of volatile or non-volatile memory, hard drives, solid state drives, flash storage devices, and/or optical storage devices (e.g., CDs, DVDs, etc.), among others. As used herein, the terms "computer-readable media" and "computer-readable medium" can include signals. In contrast, the terms "computer-readable storage media" and "computer-readable storage medium" excludes signal. Computer-readable storage media includes "computer-readable storage devices." Examples of computer-readable storage devices include volatile storage media, such as RAM, and non-volatile storage media, such as hard drives, optical discs, solid state drives, NVMe hard disk drives, flash memory, etc.

In some cases, the devices are configured with a general-purpose hardware processor and storage resources. Processors and storage can be implemented as separate components or integrated together as in computational RAM. In other cases, a device can include a system on a chip (SOC) type design. In SOC design implementations, functionality provided by the device can be integrated on a single SOC or multiple coupled SOCs. One or more associated processors can be configured to coordinate with shared resources, such as memory, storage, etc., and/or one or more dedicated resources, such as hardware blocks configured to perform certain specific functionality. Thus, the term “processor,” “hardware processor” or “hardware processing unit” as used herein can also refer to central processing units (CPUs), graphical processing units (GPUs), neural processing units (NPUs), controllers, microcontrollers, processor cores, or other types of processing devices suitable for implementation both in conventional computing architectures as well as SOC designs.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In some configurations, any of the modules/code discussed herein can be implemented in software, hardware, and/or firmware. In any case, the modules/code can be provided during manufacture of the device or by an intermediary that prepares the device for sale to the end user. In other instances, the end user may install these modules/code later, such as by downloading executable code and installing the executable code on the corresponding device.

Also note that devices generally can have input and/or output functionality. For example, computing devices can have various input mechanisms such as keyboards, mice, touchpads, voice recognition, gesture recognition (e.g., using depth cameras such as stereoscopic or time-of-flight camera systems, infrared camera systems, RGB camera systems or using accelerometers/gyroscopes, facial recognition, etc.), microphones, etc. Devices can also have various output mechanisms such as printers, monitors, speakers, etc.

Also note that the devices described herein can function in a stand-alone or cooperative manner to implement the described techniques. For example, the methods and functionality described herein can be performed on a single computing device and/or distributed across multiple computing devices that communicate over network(s) 550. Without limitation, network(s) 550 can include one or more local area networks (LANs), wide area networks (WANs), the Internet, and the like.

### ADDITIONAL EXAMPLES

Various examples are described above. Additional examples are described below. One example includes a method comprising, by a processing unit, sending, to an interposer, a request to perform a write operation to write data to a storage device, receiving, from the interposer, an initialization value for the write operation, performing data at rest encryption on the data using the initialization value, the data at rest encryption resulting in encrypted data, and sending the encrypted data to the interposer, where the interposer writes the encrypted data to the storage device.

Another example can include any of the above and/or below examples where the initialization value is a tweak value that is based on a logical block address where the encrypted data is stored on the storage device.

Another example can include any of the above and/or below examples where the data at rest encryption involves using a tenant-specific encryption key and the tweak value.

Another example can include any of the above and/or below examples where the data at rest encryption can be performed with AES-XTS

Another example can include any of the above and/or below examples where the method further comprises, by the processing unit, sending control data to the interposer with the encrypted data.

Another example can include any of the above and/or below examples where the method further comprises, by the processing unit, performing link encryption on the control data prior to sending the control data to the interposer.

Another example can include any of the above and/or below examples where the link encryption can be performed with AES-GCM.

Another example can include any of the above and/or below examples where the processing unit does not perform the link encryption on the encrypted data that is written to the storage device.

Another example can include any of the above and/or below examples where the method further comprises, by the processing unit, sending, to the interposer, a request to perform a read operation to read the encrypted data from the storage device and receiving, from the interposer, the encrypted data and an initialization value for the read operation.

Another example includes a system comprising a processing unit, a memory, an interposer, and a storage device, the memory having instructions which, when executed by the processing unit, cause the processing unit to send, to the interposer, a request to perform a write operation to write data to a storage device, receive, from the interposer, an initialization value for the write operation, perform data at rest encryption on the data using the initialization value, the data at rest encryption resulting in encrypted data, and send the encrypted data to the interposer, where the interposer is configured to write the encrypted data to the storage device.

Another example can include any of the above and/or below examples where the initialization value is a tweak value that is based on a logical block address where the encrypted data is stored on the storage device.

Another example can include any of the above and/or below examples where the data at rest encryption involves using a tenant-specific encryption key and the tweak value.

Another example can include any of the above and/or below examples where the data at rest encryption can be performed with AES-XTS

Another example can include any of the above and/or below examples where the instructions, when executed by the processing unit, cause the processing unit to send control data to the interposer with the encrypted data.

Another example can include any of the above and/or below examples where the instructions, when executed by the processing unit, cause the processing unit to perform link encryption on the control data prior to sending the control data to the interposer.

Another example can include any of the above and/or below examples where the link encryption can be performed with AES-GCM

Another example can include any of the above and/or below examples where the processing unit does not perform the link encryption on the encrypted data that is written to the storage device.

Another example can include any of the above and/or below examples where the instructions, when executed by the processing unit, cause the processing unit to send, to the interposer, a request to perform a read operation to read the encrypted data from the storage device and receive, from the interposer, the encrypted data and an initialization value for the read operation.

Another example can include any of the above and/or below examples where the storage device can be a solid-state drive.

Another example includes a computer-readable storage medium storing instructions which, when executed by a processing device, cause the processing device to perform acts comprising sending, to an interposer, a request to perform a write operation to write data to a storage device, receiving, from the interposer, an initialization value for the write operation, performing data at rest encryption on the data using the initialization value, the data at rest encryption resulting in encrypted data, and sending the encrypted data to the interposer, where the interposer writes the encrypted data to the storage device.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other features and acts that would be recognized by one skilled in the art are intended to be within the scope of the claims.

1. A method comprising:
by a processing unit:
sending, to an interposer, a request to perform a write operation to write data to a storage device;
receiving, from the interposer, an initialization value for the write operation;
performing data at rest encryption on the data using the initialization value, the data at rest encryption resulting in encrypted data; and
sending the encrypted data to the interposer,
wherein the interposer writes the encrypted data to the storage device.

2. The method of claim 1, wherein the initialization value is a tweak value that is based on a logical block address where the encrypted data is stored on the storage device.

3. The method of claim 2, wherein the data at rest encryption involves using a tenant-specific encryption key and the tweak value.

4. The method of claim 3, the data at rest encryption being performed with AES-XTS.

5. The method of claim 1, further comprising, by the processing unit:
sending control data to the interposer with the encrypted data.

6. The method of claim 5, further comprising, by the processing unit:
performing link encryption on the control data prior to sending the control data to the interposer.

7. The method of claim 6, the link encryption being performed with AES-GCM.

8. The method of claim 6, wherein the processing unit does not perform the link encryption on the encrypted data that is written to the storage device.

9. The method of claim 1, further comprising:
by the processing unit:
sending, to the interposer, a request to perform a read operation to read the encrypted data from the storage device; and
receiving, from the interposer, the encrypted data and an initialization value for the read operation.

10. A system comprising:
a processing unit;
a memory;
an interposer; and
a storage device,
the memory having instructions which, when executed by the processing unit, cause the processing unit to:
send, to the interposer, a request to perform a write operation to write data to a storage device;
receive, from the interposer, an initialization value for the write operation;
perform data at rest encryption on the data using the initialization value, the data at rest encryption resulting in encrypted data; and
send the encrypted data to the interposer,
wherein the interposer is configured to write the encrypted data to the storage device.

11. The system of claim 10, wherein the initialization value is a tweak value that is based on a logical block address where the encrypted data is stored on the storage device.

12. The system of claim 11, wherein the data at rest encryption involves using a tenant-specific encryption key and the tweak value.

13. The system of claim 12, the data at rest encryption being performed with AES-XTS.

14. The system of claim 10, wherein the instructions, when executed by the processing unit, cause the processing unit to:
send control data to the interposer with the encrypted data.

15. The system of claim 14, wherein the instructions, when executed by the processing unit, cause the processing unit to:
perform link encryption on the control data prior to sending the control data to the interposer.

16. The system of claim 15, the link encryption being performed with AES-GCM.

17. The system of claim 15, wherein the processing unit does not perform the link encryption on the encrypted data that is written to the storage device.

18. The system of claim 10, wherein the instructions, when executed by the processing unit, cause the processing unit to:
send, to the interposer, a request to perform a read operation to read the encrypted data from the storage device; and
receive, from the interposer, the encrypted data and an initialization value for the read operation.

19. The system of claim 10, the storage device being a solid-state drive.

20. A computer-readable storage medium storing instructions which, when executed by a processing device, cause the processing device to perform acts comprising:
sending, to an interposer, a request to perform a write operation to write data to a storage device;
receiving, from the interposer, an initialization value for the write operation;
performing data at rest encryption on the data using the initialization value, the data at rest encryption resulting in encrypted data; and
sending the encrypted data to the interposer,
wherein the interposer writes the encrypted data to the storage device.
